(19) United States
(12) Patent Application Publication
(10) Pub. No.: US 2008/0226985 A1
(43) Pub. Date: Sep. 18, 2008

(54) ELECTROCHEMICAL CELL

(76) Inventors: Tomoki NOBUTA, Sendai-shi (JP); Toshihiko NISHIYAMA, Sendai-shi (JP); Naoki TAKAHASHI, Sendai-shi (JP); Takashi MIZUKOSHI, Sendai-shi (JP); Tetsuya YOSHINARI, Sendai-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/928,552

(22) Filed: Oct. 30, 2007

(30) Foreign Application Priority Data
Nov. 6, 2006 (JP) 2006-299973

(51) Int. Cl. H01M 4/60; H01M 4/36; H01M 6/14

(52) U.S. Cl. 429/212; 429/218.1; 429/204

(57) ABSTRACT

An electrochemical cell containing, as an electrode active material, a polyphenylquinoxaline compound represented by formula 1:

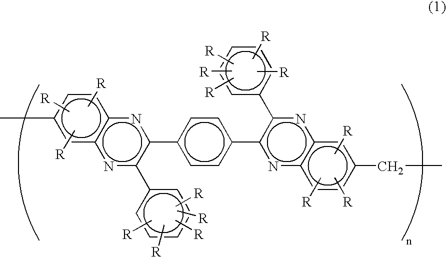

### BACKGROUND OF THE INVENTION

1. Field of the Invention

The present invention relates to an electrochemical cell such as a secondary battery, an electric double layer capacitor, a redox capacitor and a condenser.

2. Description of the Related Art

There have been suggested and practically used electrochemical cells such as secondary batteries, electric double layer capacitors, a redox capacitor and a condenser in which a proton-conducting compound is used as an electrode active material. These devices are called electrochemical cells.

Such an electrochemical cell has a basic element, for example, shown in the cross-sectional view of FIG. 1. Specifically, as shown in FIG. 1, on a cathodic current collector 1 and an anodic current collector 4 are formed a cathode 2 and an anode 3 comprising a proton-conducting compound as an electrode active material, respectively, which are laminated via a separator 5, and its operation involves only protons as a charge carrier. The cell is filled with an aqueous or nonaqueous solution containing a proton-donating electrolyte as an electrolytic solution, and is sealed by a gasket 6.

The cathode 2 and the anode 3 are generally prepared by using an electrode material that contains a powdery doped or undoped proton-conducting compound, a conductive auxiliary and a binder. An electrode can be formed by placing the electrode material in a mold with a desired size and forming a solid electrode by a hot press, or alternatively by applying a slurry of the electrode material on a conducting substrate by screen printing and drying it to form a coating electrode. The cathode 2 and the anode 3 thus formed are disposed facing each other via a separator 5, to form a basic element 100. This basic element is laminated in one or multiple layers, which is packed in a case to form an electrochemical cell.

A proton-conducting compound used as an electrode active material includes a proton-conducting polymer, which is then doped to form a redox pair, resulting in development of conductivity. This polymer can be selectively used as a cathode active material or an anode active material by appropriately adjusting its redox-potential difference.

Known electrolytic solutions include an aqueous electrolytic solution consisting of an aqueous acid solution and a non-aqueous electrolytic solution based on an organic solvent, and when using a proton-conducting polymer, the former aqueous electrolytic solution has been generally used because it can provide a particularly high capacity cell.

Examples of a compound which has been suitably used as an electrode material for such an electrochemical cell include polyphenylquinoxalines (for example, JP-A-2000-260422 (the corresponding Japanese Patent No. 3144410)) represented by formula 2 and polyphenylquinoxaline ethers (for example, JP-A-2001-319655) represented by formula 3. JP-A-2000-260422 relates to a battery and a capacitor, comprising an electrode in which a material containing a quinoxaline resin and an electrolyte containing sulfate or sulfonate ions is used. By using a polyphenylquinoxaline as an anode material, a higher energy density has been achieved in a battery and a capacitor. JP-A-2001-319655 relates to a secondary battery and a capacitor, wherein an electrode active material is a polyquinoxaline ether in which an ether bond is introduced in a polyquinoxaline. By introducing an ether bond in a polymer backbone, its molecular weight is increased, resulting in improvement of cycle properties and cost reduction.

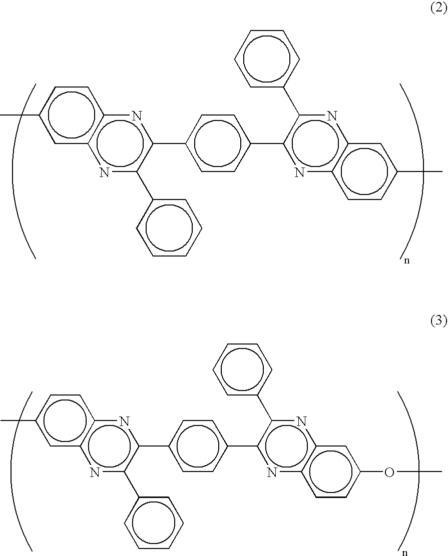

However, for the above polyphenylquinoxalines, starting materials for their synthesis and thus a polymer are expensive, and therefore, a product prepared using these materials is expensive. Furthermore, a polyphenylquinoxaline ether has a smaller redox potential, so that it has a smaller capacity in a charge/discharge potential range similar to a polyphenylquinoxaline. In addition, a capacitor may be increased by charging to a less-noble potential side, but in such a case, overcharge may accelerate material deterioration, leading to deterioration in high-temperature cycle properties.

### SUMMARY OF THE INVENTION

In view of the problems, an objective of the present invention is to provide an inexpensive electrochemical cell having good high-temperature cycle properties, using an inexpensive electrode material.

According to an aspect of the present invention, there is provided an electrochemical cell comprising, as an electrode active material, a polyphenylquinoxaline compound represented by formula 1:

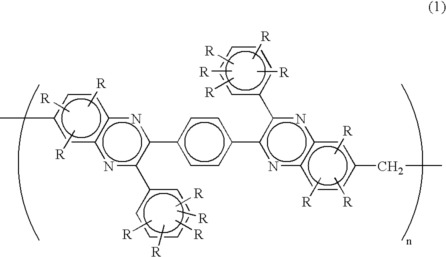

wherein R is independently a hydrogen atom, a hydroxyl group, a carboxyl group, a nitro group, a phenyl group, a vinyl group, a halogen atom, an acetyl group, an acyl group, a cyano group, an amino group, a trifluoromethyl group, a sulfonyl group, a sulfonic group, a trifluoromethylthio group, a carboxylate group, a sulfonate group, an alkoxyl group, an alkylthio group, an arylthio group, an alkyl group having 1 to 20 carbon atoms optionally substituted by any of these substituents, an aryl group having 2 to 20 carbon atoms optionally substituted by any of these substituents, an aryl group having 2 to 20 carbon atoms and optionally a heteroatom, or a heterocyclic residue.

The term “independently” as used herein means that in each repeating unit and in each motif, all of the specified moiety may be the same or different, and indicates that they are independent in each structure in a polymer.

It is desirable that an electrochemical cell of the present invention contains a conductive auxiliary made of fibrous or particulate carbon. It is also desirable that the cell contains an electrolyte containing a proton source and operates by a mechanism involving proton adsorption/desorption in an electrode active material in a redox reaction associated with charge/discharge. The above electrolyte preferably contains sulfuric acid as a proton source. More preferably, the cell contains the above electrode active material as an anode active material and a proton-conducting compound as a cathode active material.

According to another aspect of the present invention, there is provided an electrochemical cell comprising:

an anode containing, as an anode active material, a polyphenylquinoxaline compound represented by formula 1:

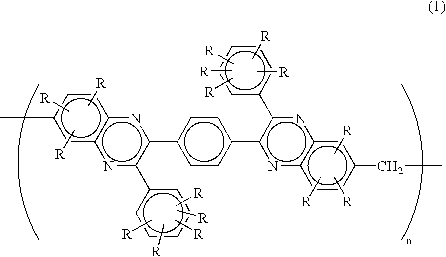

wherein R is independently a hydrogen atom, a hydroxyl group, a carboxyl group, a nitro group, a phenyl group, a vinyl group, a halogen atom, an acetyl group, an acyl group, a cyano group, an amino group, a trifluoromethyl group, a sulfonyl group, a sulfonic group, a trifluoromethylthio group, a carboxylate group, a sulfonate group, an alkoxyl group, an alkylthio group, an arylthio group, an alkyl group having 1 to 20 carbon atoms optionally substituted by any of these substituents, an aryl group having 2 to 20 carbon atoms optionally substituted by any of these substituents, an aryl group having 2 to 20 carbon atoms and optionally a heteroatom, or a heterocyclic residue;

a cathode containing, as a cathode active material, a proton-conducting compound;

a separator disposed between the anode and the cathode; and

an electrolyte containing a proton source.

The present invention can provide an inexpensive electrochemical cell having improved high-temperature cycle properties.

### BRIEF DESCRIPTION OF THE DRAWINGS

FIG. 1 is a cross-sectional view of a basic element in an electrochemical cell.

FIG. 2 is a cross-sectional view of an electrochemical cell with terminals.

FIG. 3 is a cross-sectional view of a button type electrochemical cell.

FIG. 4 shows discharge capacity curves for the batteries in Example 1 according to the present invention and Comparative Examples 1 and 2 of the prior art.

### DETAILED DESCRIPTION OF PREFERRED EMBODIMENTS

An electrochemical cell according to an embodiment of the present invention contains a polyphenylquinoxaline compound represented by formula 1 as an electrode active material.

In an electrochemical cell employing a quinoxaline material as an electrode active material, a reaction during charge/discharge in the quinoxaline material is a redox reaction in a π-conjugated system of a quinoxaline ring, where the reaction proceeds in association with proton adsorption/desorption. Using a polyphenylquinoxaline compound represented by formula 1 as this quinoxaline material, the following effects can be achieved.

1) Introduction of a methylene bond (methylene group) to a main backbone (main chain) of a polyquinoxaline material causes variation of an electron transfer resistance in the polymer to change a redox potential, resulting in shift to a noble potential compared with an ether system (where an ether bond is introduced). Thus, when it is used as an anode active material, a high capacity can be obtained at a low voltage and deterioration of the electrode material due to overcharge can be prevented.

2) Since a methylene group has a relatively small molecular weight, introduction of a methylene group does not significantly reduce a theoretical capacity, and thus a redox potential little varies, resulting in a substantially comparable capacity. Additionally, introduction of a methylene group interrupts an electron conjugated system connecting between quinoxaline monomer units. It is probably that such structural difference effectively control deterioration in comparison with a polyphenylquinoxaline of the prior art.

From the above 1) and 2), the present invention can provide an electrochemical cell having improved high-temperature cycle properties by preventing material deterioration while maintaining an adequate capacity.

3) Introduction of a methylene bond results in reduction of a cost for starting materials, so that a cost of the polymer can be reduced. Consequently, the present invention can provide an electrochemical cell with a lower cost.

There will be described embodiments of the present invention with reference to the drawings.

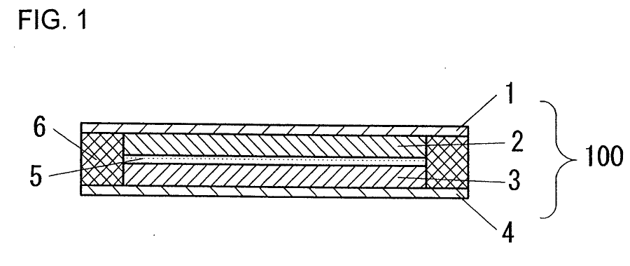

FIG. 1 is a cross-sectional view of a basic element of an electrochemical cell. There will be described a configuration of a proton-conducting polymer battery as an exemplary electrochemical cell and a manufacturing process therefor.

A basic element 100 in a proton-conducting polymer battery has a configuration where a cathode 2 and an anode 3 are formed on a cathode current collector 1 and an anode current collector 4, respectively, and these are laminated via a separator 5, and its operation involves protons as an exclusive charge carrier. In addition, it is filled with an aqueous or non-aqueous solution containing a proton source as an electrolytic solution, and sealed by a gasket 6.

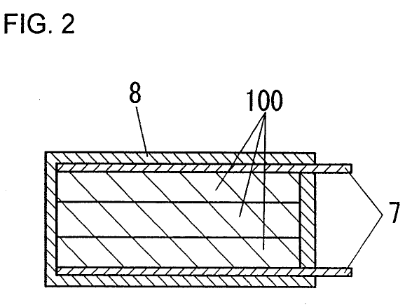

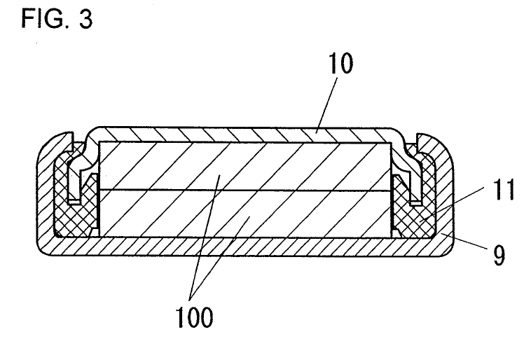

FIG. 2 is a cross-sectional view of an electrochemical cell with terminals, while FIG. 3 is a cross-sectional view of a button type electrochemical cell.

An electrochemical cell with terminals has a configuration where after stacking a given number of the basic elements 100, lead terminals made of a metal are formed in the cathode and the anode sides and the basic elements and the lead terminals except the lead parts of the lead terminals 7 are covered by a case 8, as shown in FIG. 2.

A button type electrochemical cell has a configuration where after stacking a given number of the basic elements 100, the stack of the basic elements 100 is placed in a case 9 with a cap 10 via a packing 11, and then the system is sealed, as shown in FIG. 3.

A polyphenylquinoxaline compound represented by formula 1 in the present invention may be any of compounds having any of the above substituents as R. A redox potential varies, depending on the type of the substituent, and therefore, in the light of, for example, an electromotive force, a suitable polyphenylquinoxaline compound can be appropriately selected in response to the configuration of a counter electrode.

Examples of halogen atom for R in formula 1 include a fluorine atom, a chlorine atom, a bromine atom and an iodine atom. Examples of alkyl group for R in this formula include a methyl group, an ethyl group, a propyl group, an isopropyl group, an n-butyl group, an s-butyl group, an isobutyl group, a t-butyl group, an n-pentyl group, an n-hexyl group, an n-heptyl group and a n-octyl group. An acyl group for R in this formula is a substituent represented by —COX, in which X may be any of the above alkyl groups. An alkoxyl group for R in this formula is a substituent represented by —OX, in which X may be any of the above alkyl groups. Examples of aryl groups for R in this formula include a phenyl group, a naphthyl group and an anthryl group. The alkyl moiety in an alkylthio group for R in this formula may be any of the above alkyl groups. The aryl moiety in an arylthio group for R in this formula may be any of the above aryl groups. Examples of a heterocycle residue for R in this formula include 3- to 10-membered rings having 2 to 20 carbon atoms and 1 to 5 heteroatoms, in which the heteroatoms include an oxygen atom, a sulfur atom and a nitrogen atom.

A material for a counter electrode to the electrode containing a polyphenylquinoxaline compound represented by formula 1 in the present invention may be, for example, any compound which is oxidative/reductive in a solution containing a proton source, and/or activated carbon with no particular restrictions. The active material for a counter electrode is preferably a proton-conducting compound capable of initiating a redox reaction in a solution containing a proton source.

For example, the following proton-conducting compounds can be used; π-conjugated polymers such as polyaniline, polythiophene, polypyrrole, polyacetylene, poly-p-phenylene, polyphenylene-vinylene, polyperinaphthalene, polyfuran, polythienylene, polypyridinediyl, polyisothianaphthene, polyquinoxaline, polypyridine, polypyrimidine, polyindole, polyimidazole and their derivatives; quinone polymers and their derivatives such as polyaminoanthraquinone, polyanthraquinone, polynaphthoquinone and polybenzoquinone (where a quinone oxygen can be converted into a hydroxyl group by conjugation); and polymers containing two or more of the monomers giving the above polymers; indole π-conjugated compound including an indole trimer; quinones such as benzoquinone, naphthoquinone and anthraquinone. These compounds may be doped to form a redox pair for exhibiting conductivity. These compounds are appropriately selected as a cathode and an anode active materials, taking a redox potential difference into account.

Preferable examples of a proton-conducting compound include nitrogen-containing π-conjugated compounds or polymers.

For example, an indole trimer represented by formula 4 can be used as a cathode active material, while a polyphenylquinoxaline compound represented by formula 1 can be used as an anode active material.

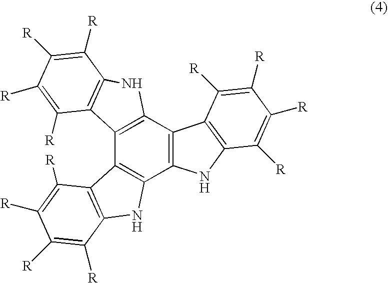

In formula 4, R is independently a hydrogen atom, a hydroxyl group, a carboxyl group, a nitro group, a phenyl group, a vinyl group, a halogen atom, an acetyl group, an acyl group, a cyano group, an amino group, a trifluoromethyl group, a sulfonyl group, a sulfonic group, a trifluoromethylthio group, a carboxylate group, a sulfonate group, an alkoxyl group, an alkylthio group, an arylthio group, an alkyl group having 1 to 20 carbon atoms optionally substituted by any of these substituents, an aryl group having 2 to 20 carbon atoms optionally substituted by any of these substituents, an aryl group having 2 to 20 carbon atoms and optionally a heteroatom, or a heterocyclic residue.

The term “independently” as used herein means that in each motif, all of the specified moiety may be the same or different.

Examples of halogen atom for R in formula 4 include fluorine atom, a chlorine atom, a bromine atom and an iodine atom. Examples of alkyl group for R in this formula include a methyl group, an ethyl group, a propyl group, an isopropyl group, an n-butyl group, an s-butyl group, an isobutyl group, a t-butyl group, an n-pentyl group, an n-hexyl group, an n-heptyl group and an n-octyl group. An acyl group for R in this formula is a substituent represented by —COX, in which X may be any of the above alkyl groups. An alkoxyl group for R in this formula is a substituent represented by —OX, in which X may be any of the above alkyl groups. Examples of aryl groups for R in this formula include a phenyl group, a naphthyl group and an anthryl group. The alkyl moiety in an alkylthio group for R in this formula may be any of the above alkyl groups. The aryl moiety in an arylthio group for R in this formula may be any of the above aryl groups. Examples of a heterocycle residue for R in this formula include 3- to 10-membered rings having 2 to 20 carbon atoms and 1 to 5 heteroatoms, in which the heteroatoms include an oxygen atom, a sulfur atom and a nitrogen atom.

A cathode and an anode can be prepared as follows. With each electrode active material is mixed fibrous carbon (trade name: VGCF, Showa Denko K.K.) or particulate carbon (trade name: Ketjen Black, Ketjen Black International) as a conductive auxiliary in 1 to 50 parts by weight, preferably 10 to 30 parts by weight to 100 parts by weight of the electrode active material. The mixed powder can be press-formed at an ambient temperature to 400° C., preferably 100 to 300° C., to prepare an electrode. Alternatively, a slurry is prepared by dispersing the mixture in a given organic solvent or water and, where necessary, a binder is added in 1 to 20 parts by weight, preferably 5 to 10 parts by weight to 100 parts by weight of the active material, and the slurry is applied to a conductive substrate by screen printing and dried to give an electrode. A conductive auxiliary is particularly preferably Ketjen Black EC600JD (trade name) from Ketjen Black International because it has a higher specific surface area and an adequate electrode conductivity can be attained by adding it in a small amount. There are no particular restrictions to a binder, and preferred are polyvinylidene fluoride (PVdF) and polytetrafluoroethylene (PTFE). There are no particular restrictions to its molecular weight as long as it can be dissolved in a solvent used, and a binder having such a molecular weight can be used.

An electrolyte containing a proton source may be an electrolytic solution as an aqueous or non-aqueous proton-containing solution, that is a proton-ionizing electrolyte. For example, an acid as a proton source may be selected from organic and inorganic acids; examples of an inorganic acid include sulfuric acid, nitric acid, hydrochloric acid, phosphoric acid, tetrafluoroboronic acid, hexafluorophosphoric acid and hexafluorosilic acid, and examples of an organic acid include saturated monocarboxylic acids, aliphatic carboxylic acids, oxycarboxylic acids, p-toluenesulfonic acid, polyvinylsulfonic acid and lauric acid. Among these electrolytes containing a proton source, an acid-containing aqueous solution is preferable, and an aqueous sulfuric acid solution is particularly preferable. The amount of protons is preferably 10⁻³ mol/L to 18 mol/L, more preferably 10⁻¹ mol/L to 7 mol/L.

There are no particular restrictions to a separator as long as it can electrically insulate between a cathode and an anode in an electrochemical cell, and any of such separators can be used. Examples may include polyolefin porous films and ion-exchange membranes. Its thickness is preferably, but not limited to, 10 to 200 μm, more preferably 10 to 80 μm.

A case for an electrochemical cell may have, but not limited to, a coin- or laminate-shape.

An electrochemical cell of the present invention is preferably a cell which can operate such that a redox reaction in association with charge/discharge involves protons as an exclusive charge carrier, more specifically a cell containing a proton-source-containing electrolyte which can operate such that electron transfer in a redox reaction in association with charge/discharge involves exclusively proton adsorption/desorption in an electrode active material.

### EXAMPLES

There will be further described the present invention with reference to, but not limited to, the following examples.

### Example 1

### Example 1-1

### Measurement of a CV

A polyquinoxaline compound represented by formula 5 in which a methylene bond was introduced in a main backbone as an anode active material and Ketjen Black EC600JD (trade name; Ketjen Black International) as a conductive auxiliary were weighed in a weight ratio of 75:25. To the mixture was added metacresol to obtain a paste, which was then applied to a 50 mm×5 mm carbon sheet having a thickness of 100 μm and dried at 120° C. for one hour, to prepare an electrode sheet (its electrode film thickness: 2 μm to 3 μm).

The electrode sheet thus obtained was immersed in a 40 wt % aqueous solution of sulfuric acid and subjected to measurement under the conditions of a sweep potential: 500 to −100 mV and a sweep speed: 1 mV/sec. A reference electrode was an Ag/AgCl electrode and a counter electrode was platinum.

An oxidative capacity (CV capacity) was 265 C/g. A redox potential was −17 mV. The measurement results are shown in Table 1.

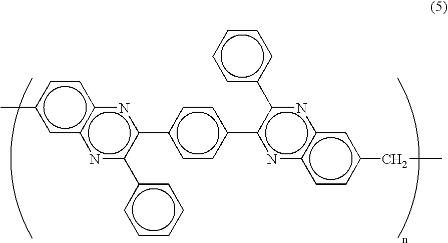

### Example 1-2

### Measurement of an Anode Capacity

A polyquinoxaline compound represented by formula 5 in which a methylene bond was introduced in a main backbone as an anode active material and Ketjen Black EC600JD (trade name; Ketjen Black International) as a conductive auxiliary were weighed in a weight ratio of 75:25. They were stirred and mixed by a blender, and pressed to give a 3 mm (length)×4 mm (width) anode having a thickness of 1.0 mm. An electrode density was 0.9 g/cm³.

A cathode was prepared as described in Example 1-3.

The electrodes were chemically doped using a 40 wt % aqueous solution of sulfuric acid.

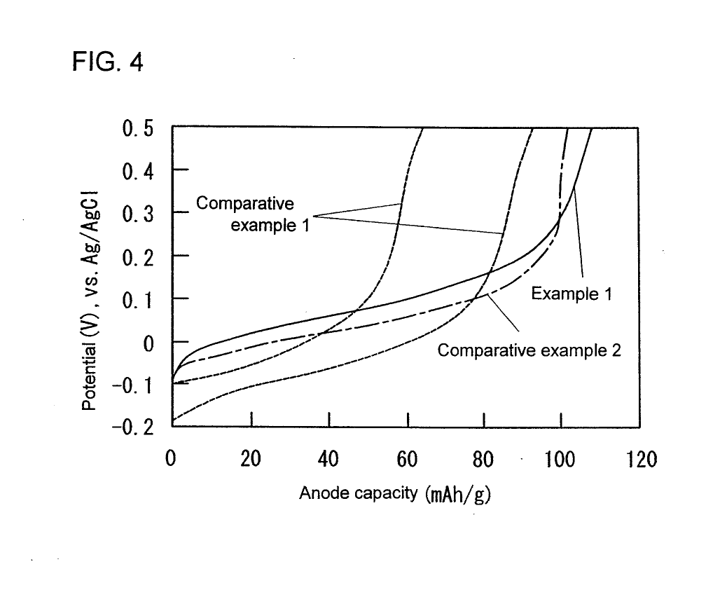

The anode and the counter electrode (cathode) were placed such that they faced each other via a separator impregnated with an electrolytic solution, and then a charge/discharge capacity of the anode was measured. As the measurement conditions, it was charged at a constant current of 8.3 mA/cm² to −0.1 V, and was discharged at a constant current of 8.3 mA/cm² to +0.5 V. Anode potential was only controlled using an Ag/AgCl reference electrode. A discharge capacity (anode capacity) was 108 mAh/g. Table 1 shows the measurement results and FIG. 4 shows a discharge capacity curve.

### Example 1-3

### Battery Cycle Test

For a cathode, a methyl indole-6-carboxylate trimer (a compound represented by formula 4, where R at 6-position in each indole moiety is a methyl carboxylate group) was selected as a cathode active material; a fibrous carbon (trade name: VGCF, Showa Denko K.K.) was selected as a conductive auxiliary; and PTFE was selected as a binder. These were weighed in a weight ratio of 69:23:8 to give a slurry, which was applied to a carbon sheet to form a cathode sheet having a diameter of 12 mm and a thickness of 200 μm (its cathode film thickness: 100 μm, the carbon sheet thickness: 100 μm).

An anode was prepared as described in Example 1-2, to give an anode having a diameter of 12 mm and a thickness of 200 μm.

An electrolytic solution was a 20 wt % aqueous sulfuric acid solution. A separator was a porous unwoven fabric having a thickness of 50 μm.

Via this separator, the cathode and the anode were laminated such that their electrode sides faced each other, and the product was covered by a gasket to prepare an electrochemical element, that is a coin type electrochemical cell.

This electrochemical cell was evaluated for its cycle properties at 45° C. In the evaluation, it was charged at constant current/voltage (10 mA, 1.2V, 10 min), and was discharged at a constant current (5 mA) to 0 V. This procedure was repeated five thousand cycles. A residual capacity ([capacity after five thousand cycles/initial capacity]×100%) was 82%. Table 1 shows the measurement results.

### Comparative Example 1

A sheet electrode was prepared and its CV was measured as described in Example 1-1, using a polyphenylquinoxaline ether represented by formula 3 as an anode active material. An oxidative capacity (CV capacity) was 164 C/g. A redox potential was −86 mV. Table 1 shows the measurement results.

An anode was prepared and an anode capacity was measured as described in Example 1-2, using a polyphenylquinoxaline ether represented by formula 3 as an anode active material. A discharge capacity (anode capacity) was 64 mAh/g. Furthermore, an additional measurement was conducted. After the anode was overcharged to −0.2 V, a capacity of 93 mAh/g was obtained, which was substantially comparable to that in Example 1-2 according to the present invention (test conditions: charge at a constant current of 8.3 mA/cm² to −0.2 V, and then discharge at a constant current of 8.3 mA/cm² to +0.5 V). Table 1 shows the measurement results and FIG. 4 shows a discharge capacity curve.

An electrochemical cell was prepared as described in Example 1-3, using a polyphenylquinoxaline ether represented by formula 3 as an anode active material. Cycle properties were evaluated as described in Example 1-3, except that a charge voltage was set to 1.35 V for obtaining a battery capacity comparable to that in Example 1-2 according to the present invention. A residual capacity rate after five thousand cycles was 43%. Table 1 shows the measurement results.

### Comparative Example 2

A sheet electrode, a molded electrode and an electrochemical cell were prepared as described in Example 1-1, 1-2 and 1-3, respectively, using a polyphenylquinoxaline represented by formula 2 as an anode active material, and their properties were evaluated. Table 1 shows the measurement results and FIG. 4 shows a discharge curve.

TABLE 1

| | | | Redox | | Cycle |
|---|---|---|---|---|---|
| | | CV | poten- | | properties |
| | Binding | capacity | tial | Anode capacity | (residual |
| | group | (C/g) | (mV) | (mAh/g) | rate %) |
| Example 1 | Methylene | 265 | −17 | 108 | 82 |
| Comp. | Ether | 164 | −86 | 64 | 43 |
| Example 1 | | | | (the same | |
| | | | | conditions as | |
| | | | | those in | |
| | | | | Example 1, −0.1 | |
| | | | | V charge) | |
| | | | | 93 | |
| | | | | (overcharge, −0.2 | |
| | | | | V charge) | |
| Comp. | None | 270 | −21 | 102 | 75 |
| Example 2 | | | | | |

As seen in Table 1, Example 1 according to the present invention has a nobler redox potential and a larger capacity than Comparative Example 1 in which an anode active material was a polyphenylquinoxaline ether represented by formula 3. When employing a comparable capacity in Comparative Example 1, cycle properties are deteriorated.

1. An electrochemical cell comprising, as an electrode active material, a polyphenylquinoxaline compound represented by formula 1: 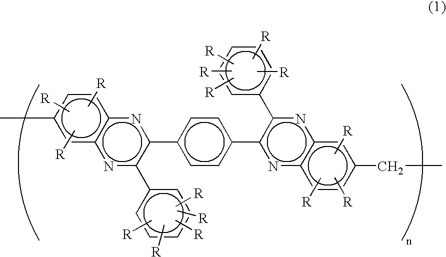
wherein R is independently a hydrogen atom, a hydroxyl group, a carboxyl group, a nitro group, a phenyl group, a vinyl group, a halogen atom, an acetyl group, an acyl group, a cyano group, an amino group, a trifluoromethyl group, a sulfonyl group, a sulfonic group, a trifluoromethylthio group, a carboxylate group, a sulfonate group, an alkoxyl group, an alkylthio group, an arylthio group, an alkyl group having 1 to 20 carbon atoms optionally substituted by any of these substituents, an aryl group having 2 to 20 carbon atoms optionally substituted by any of these substituents, an aryl group having 2 to 20 carbon atoms and optionally a heteroatom, or a heterocyclic residue.

2. The electrochemical cell as claimed in claim 1, comprising, in addition to the electrode active material, a conductive auxiliary made of fibrous or particulate carbon.

3. The electrochemical cell as claimed in claim 1, comprising an electrolyte containing a proton source, wherein proton adsorption/desorption in the electrode active material is involved in a redox reaction in association with charge/discharge.

4. The electrochemical cell as claimed in claim 3, wherein the electrolyte contains sulfuric acid as a proton source.

5. The electrochemical cell as claimed in claim 1, comprising a polyphenylquinoxaline compound represented by formula 1 as an anode active material and a proton-conducting compound as a cathode active material.

6. An electrochemical cell comprising:
an anode containing a polyphenylquinoxaline compound, as an anode active material, represented by formula 1: 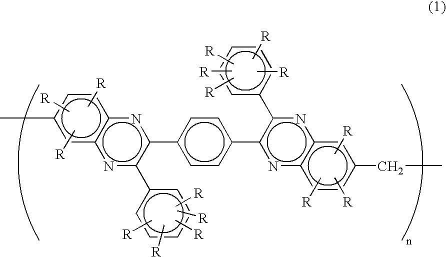
wherein R is independently a hydrogen atom, a hydroxyl group, a carboxyl group, a nitro group, a phenyl group, a vinyl group, a halogen atom, an acetyl group, an acyl group, a cyano group, an amino group, a trifluoromethyl group, a sulfonyl group, a sulfonic group, a trifluoromethylthio group, a carboxylate group, a sulfonate group, an alkoxyl group, an alkylthio group, an arylthio group, an alkyl group having 1 to 20 carbon atoms optionally substituted by any of these substituents, an aryl group having 2 to 20 carbon atoms optionally substituted by any of these substituents, an aryl group having 2 to 20 carbon atoms and optionally a heteroatom, or a heterocyclic residue;
a cathode containing a proton-conducting compound as a cathode active material;
a separator disposed between the anode and the cathode; and
an electrolyte containing a proton source.

7. The electrochemical cell as claimed in claim 5, wherein the proton-conducting compound includes nitrogen-containing π-conjugated compounds or polymers.

8. The electrochemical cell as claimed in claim 7, wherein the nitrogen-containing π-conjugated compounds or polymers is an indole trimer represented by formula 2: 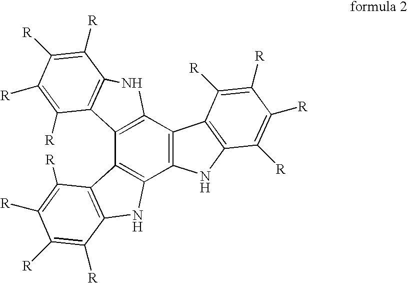
wherein R is independently a hydrogen atom, a hydroxyl group, a carboxyl group, a nitro group, a phenyl group, a vinyl group, a halogen atom, an acetyl group, an acyl group, a cyano group, an amino group, a trifluoromethyl group, a sulfonyl group, a sulfonic group, a trifluoromethylthio group, a carboxylate group, a sulfonate group, an alkoxyl group, an alkylthio group, an arylthio group, an alkyl group having 1 to 20 carbon atoms optionally substituted by any of these substituents, an aryl group having 2 to 20 carbon atoms optionally substituted by any of these substituents, an aryl group having 2 to 20 carbon atoms and optionally a heteroatom, or a heterocyclic residue.

9. The electrochemical cell as claimed in claim 2, wherein the fibrous carbon or the particulate carbon is contained in 1 to 50 parts by weight relative to 100 parts by weight of the electrode active material.

10. An electrode comprising a polyphenylquinoxaline compound represented by formula 1 as an electrode active material: 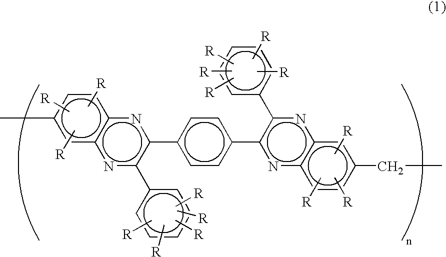
wherein R is independently a hydrogen atom, a hydroxyl group, a carboxyl group, a nitro group, a phenyl group, a vinyl group, a halogen atom, an acetyl group, an acyl group, a cyano group, an amino group, a trifluoromethyl group, a sulfonyl group, a sulfonic group, a trifluoromethylthio group, a carboxylate group, a sulfonate group, an alkoxyl group, an alkylthio group, an arylthio group, an alkyl group having 1 to 20 carbon atoms optionally substituted by any of these substituents, an aryl group having 2 to 20 carbon atoms optionally substituted by any of these substituents, an aryl group having 2 to 20 carbon atoms and optionally a heteroatom, or a heterocyclic residue.
